(19) United States
(12) Patent Application Publication
(10) Pub. No.: US 2023/0215295 A1
(43) Pub. Date: Jul. 6, 2023

(54) SPATIALLY ACCURATE SIGN LANGUAGE CHOREOGRAPHY IN MULTIMEDIA TRANSLATION SYSTEMS

(71) Applicant: T-Mobile Innovations LLC, Overland Park, KS (US)

(72) Inventor: Ali Daniali, Tukwila, WA (US)

(21) Appl. No.: 17/566,994

(22) Filed: Dec. 31, 2021

(51) Int. Cl. G09B 21/00; G06T 13/40; G06V 40/20; G06V 40/10; G06V 10/82; H04N 21/2187; G06N 3/02

(52) U.S. Cl. CPC G09B 21/009; G06T 13/40; G06V 40/28; G06V 40/113; G06V 10/82; H04N 21/2187; G06N 3/02

(57) ABSTRACT

Systems, methods, and computer-readable media herein provide for real-time manipulation and animation of 3D rigged virtual models to generate sign language translation. Source video and audio data associated with content is provided to a neural network to determine choreographic actions that may be used to modify and animate the articulation control points of a 3D model within a 3D space. The animated 3D virtual model may be presented in relation to the source content to provide sign language translation of the source content.

### BACKGROUND

Broadcasts, audio/video streams, and live events are viewed or attended by billions of viewers or attendees every year including some of the approximately 5 percent of the global population that have at least some level of hearing loss, impairment, or degradation. Some individuals with hearing impairment rely on sign (signed) languages (e.g., visually conveyed communication) to communicate or consume information. Often, in the case of live events, video recordings, or video streams, a human interpreter may be provided or otherwise be present to translate between audible speech and communication and a sign language such that individuals relying on the sign language may receive information and content associated with the audible speech. These interpreters are tasked with listening to spoken communication and quickly producing the appropriate facial expressions and hand motions (also referred to as “signs”) or gestures, so that the visible aspects of a particular content may be synchronized with the translation with minimal lag. Thus, the interpreter must quickly translate not only a speaker's words, but also their inflections, emphasis, and other aspects of the communication.

Using sign language interpreters presents numerous limitations. Interpretation often requires a translation response and corresponding hand expressions with minimal delay or lag. As such, prolonged periods of sign language translation may cause fatigue for the human interpreter and potential inaccuracy of the translation. In many circumstances, multiple translators work in shifts to limit fatigue. However, this increases the number of necessary translators that are needed to provide translation for a particular event or piece of content. This may present problems for finding candidates and filling translator task assignments, especially in spontaneous, informal, and/or low cost content generation and presentation. For example, a smaller event or presentation, such as over a streaming video meeting software, may not ordinarily use a sign language interpreter. Similarly, many videos or other content is produced without native or accompanying sign language translation.

Another limitation of conventional sign language interpreters is that there is always a lag in the translation of spoken word to sign language.

### SUMMARY

The present disclosure is directed, in part, to spatially accurate sign language choreography in multimedia translation systems, substantially as shown in and/or described in connection with at least one of the figures, and as set forth more completely in the claims. In contrast to conventional approaches, a 2D and/or 3D rigged model (e.g., virtual avatar or animated model) may be presented in relation to video and/or audio content to translate portions of the content into one or more spatially accurate sign languages. For example a 3D animation of a rigged model may be displayed in relation to a source video such that the 3D animation exhibits one or more motions corresponding to sign language actions, gestures and/or expressions. In some embodiments, a video may be translated into one or more sets of instructions that may be used to manipulate one or more features of a 2D or 3D rigged model. For example, a 3D rigged model may be configured to have one or more control points (e.g., articulation points) that allow for spatial manipulation of these points relative to one or more other control points and/or within a 2D or 3D space. As an example, a 3D rigged model may comprise skeletal frame and/or facial structure having one or more control points that act as points of articulation for the skeletal frame or facial structure such that the control points can be instructed to move or act in a manner to cause the skeletal frame or facial structure to move or perform maneuvers associated with a choreographic action (e.g., perform a sign language translation by gestures and/or expression).

The 3D animation of a rigged model may be determined from a source content (e.g., video data, audio data) using one or more neural networks and/or machine learning algorithms trained to compute choreographic actions from the source content based on verbal, non-verbal, grammatical, and/or lexicographic events associated with the source content. For example, a neural network (e.g., machine learning algorithms) may be trained to ingest source video and audio data associated with a communication (e.g., public event, broadcast, presentation, etc.) and compute choreographic actions based on events (e.g., speech, body language, and/or facial expressions of persons represented in source data) occurring in the source video and audio data. The computed choreographic actions may be used to control and dictate the movements (e.g., sign language gestures) of a rigged model (e.g., virtual avatar) which may be presented in association with the source content. A real-time signed language translation of the source content may be presented with reduced latency for any context in which source content can be analyzed. Thus, the need for human sign language interpreters may be reduced for situations in which human interpretation may be unavailable or otherwise unsuitable.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, which are intended to be exemplary and non-limiting, wherein:

FIG. 1 depicts a diagram of an sign language translation system in which implementations of the present disclosure may be employed;

FIG. 2A depicts an example of a block diagram showing a process for training machine learning algorithms for spatially accurate sign language choreography, in accordance with embodiments of the present disclosure;

FIG. 2B depicts an example of a block diagram showing a process for spatially accurate sign language choreography using machine learning algorithms, in accordance with embodiments of the present disclosure;

FIG. 3 depicts an example graphical user interface (GUI) for displaying a rigged model, in accordance with implementation of the present disclosure;

FIG. 4A depicts an example graphical user interface (GUI) for displaying a rigged model, in accordance with implementation of the present disclosure;

FIG. 4B depicts an example graphical user interface (GUI) for displaying a rigged model in augmented reality, in accordance with implementation of the present disclosure;

FIG. 5 depicts a flow chart of a method for spatially accurate sign language choreography in multimedia translation systems, in accordance with aspects of the present disclosure;

FIG. 6 depicts a flow chart of a method for spatially accurate sign language choreography in multimedia translation systems, in accordance with aspects of the present disclosure;

FIG. 7 depicts a flow chart of a method for spatially accurate sign language choreography in multimedia translation systems, in accordance with aspects of the present disclosure; and

FIG. 8 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention.

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the technology may be embodied as, among other things, a method, system, or computer-program product. Accordingly, the embodiments may take the form of a hardware embodiment, or an embodiment combining software and hardware. In one embodiment, the present invention takes the form of a computer-program product that includes computer-useable instructions embodied on one or more computer-readable media.

Computer-readable media includes volatile and/or nonvolatile media, removable and non-removable media, and contemplate media readable by a database, a switch, and various other network devices. Network switches, routers, and related components are conventional in nature, as are means of communicating with the same. By way of example and not limitation, computer-readable media comprise computer storage media and/or communications media. Computer storage media, or machine-readable media, include media implemented in any method or technology for storing information. Examples of stored information include computer-useable instructions, data structures, program modules, and other data representations. Computer storage media include RAM, ROM, EEPROM, flash memory or other memory technology, CD-ROM, digital versatile discs (DVDs), holographic media or other optical disc storage, magnetic cassettes, magnetic tape, magnetic disc storage, and/or other magnetic storage devices. These memory components can store data momentarily, temporarily, or permanently. Computer storage media does not encompass a transitory signal, in embodiments of the present invention.

Communications media typically store computer-useable instructions, including data structures and program modules, in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

At a high level, systems, methods, and computer-readable media of the present disclosure provide for spatially accurate sign language choreography in multimedia translation systems. The systems, methods, and computer-readable media disclosed herein may provide a real-time low latency sign language translations of multimedia (e.g., video and/or audio) content. By choreographing a virtual representation of a sign language using a rigged model, sign language translation can be deployed in association to a wide number of contexts for which a human sign language translation would be inefficient or unfeasible. Using a choreographed rigged model allows for sign language translation to be selectively activated and translate source content into any number of signed languages and/or dialects with minimized lag.

In a first aspect of the present disclosure, a method is provided. In embodiments, the method comprises receiving source data comprising media data. The source data may correspond to any of a number of varieties of source content such as audio streams, video streams, live media, broadcasts of live or previously recorded events, web conferencing, video game streams, or any other type of content. As an example, the source may comprise audio and video data corresponding to an online conferencing and collaboration application. The method may comprise computing one or more choreographic actions. The one or more choreographic actions may be rendered using algorithms derived from machine learnings. For example, computing the choreographic actions may involve a neural network that is applied to received source content. In some embodiments, the neural network has been trained to identify choreographic actions based on verbal and non-verbal characteristics of the source content. The method may comprise transmitting, to one or more devices, the one or more choreographic actions to cause one or more control points of a rigged model to be modified in accordance with the one or more choreographic actions. For example, the choreographic actions may be transmitted to a client device and used to cause control points of a rigged model (e.g., virtual representation) to cause the rigged model to move and/or perform actions based on the choreographic actions.

In a second aspect of the present disclosure, a system is provided. The system may comprise one or more processor and one or more computer storage hardware devices storing computer-usable instructions that, when used by the one or more processors, cause the one or more processors to receive source data. In some embodiments, the source data may comprise audio data and/or image data representative of verbal or non-verbal characteristics associated with speech. The system may include applying one or more machine learning algorithms to the source data to determine a set of choreographic actions associated with the verbal or non-verbal characteristics of the source data. For example, a machine learning algorithm may be applied to the received image data to determine, based on verbal and non-verbal aspects of the image data, to compute a set of choreographic actions that may be used to control a 2D or 3D rigged model. The system may include causing one or more control points of a rigged model to be manipulated in accordance with the set of choreographic actions. In some embodiments, the control points may be manipulated based on the set of choreographic actions determined by a machine learning algorithm that is applied to video and/or audio data.

In a third aspect of the present disclosure, computer-readable media is provided, the computer-readable media having computer-executable instructions embodied thereon that, when executed, perform a method for animating a sign language in a rigged model. In accordance with the media, source data comprising at least audio data and/or video data is received. The data may be representative of verbal or non-verbal characteristics associated with speech. For example, the source data may comprise video (and associated audio) from a live stream of one or more persons for whom the verbal and non-verbal (body language, facial expression, posture, environmental aspects, contextual, etc.) aspects may be captured in the source data. As an example, a live online stream of a presentation from a medical doctor may be represented in source data that captures the verbal aspects (e.g., spoken portions of the presentation) and also captures the non-verbal aspects (hand gestures, facial expressions, context of medical presentation, emotional cues, etc.) of speech, communication, or expression that occurs in the live online stream. In some embodiments, one or more machine learning algorithms may be applied to the source data to determine a set of choreographic actions associated with the verbal or non-verbal characteristics of the source data. For example, machine learning algorithms may be trained to ingest image and audio input data and estimate choreographic actions that translates the events and content of the source data into one or more desired dialects or variations of a sign language.

In some embodiments, based on the set of choreographic actions determined by the machine learning algorithms, one or more control points of a rigged model may be caused to be manipulated in accordance with the set of the choreographic actions. For example, control points (e.g., points of articulation) of a rigged model may be manipulated in relation to each other so that the rigged model is moved based on the control points. In some embodiments, the rigged model may be displayed within a user interface of one or more devices. For example, rigged model may be displayed and may be animated in accordance with the manipulation of the one or more control points to produce a sign language expression. In some embodiments, the animated rigged model may be displayed in the same interface as a representation of the source data, while in the same or different embodiments, the animated rigged model may be displayed in a different interface and/or device. For example, the animated rigged model may be displayed in a virtual reality (VR) or augmented reality (AR) headset and/or device.

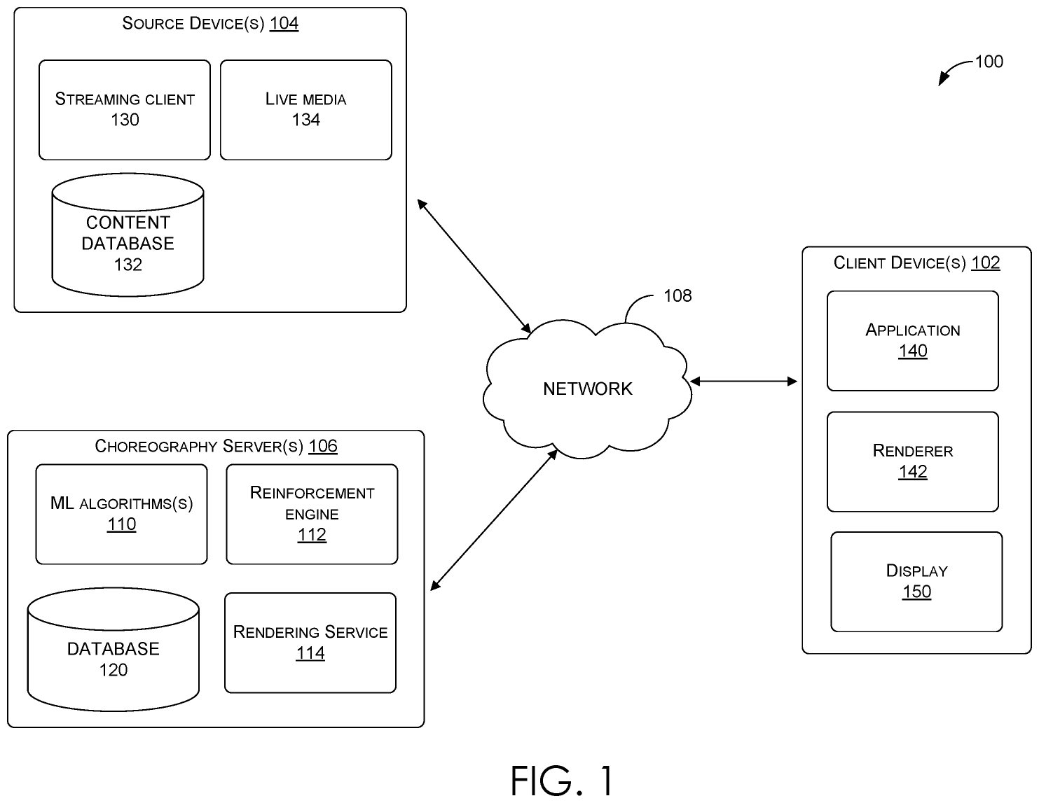

Turning now to FIG. 1, sign language translation system 100 is an exemplary system environment in which implementations of the present disclosure may be employed. Sign language translation system 100 is one example of a suitable network environment and is not intended to suggest any limitation as to the scope of use or functionality of the present disclosure. Neither should the network environment be interpreted as having any dependency or requirement relating to any one or combination of components illustrated.

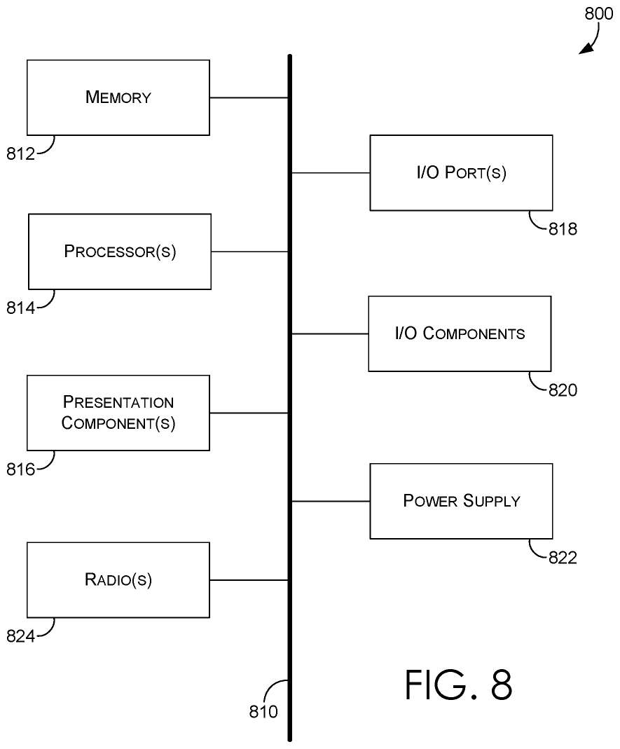

The sign language translation system 100 may include, among other things, client device(s) 102, source device(s) 104, a choreography server(s) 106, and a network 108. In any example, there may be any number of client device(s) 102, source device(s) 104, and choreography server(s) 106. The sign language translation system 100 (and the components and/or features thereof) may be implemented using one or more computing devices, such as the computing device 800 of FIG. 8, described in more detail below.

The client device(s) 102 may include a smart phone, a laptop computer, a tablet computer, a desktop computer, and/or another type of device capable of requesting and/or presenting video streams and/or 2D or 3D rendered models (e.g., rigged models). By way of example and not limitation, the client device(s) 102 may be embodied as a Personal Computer (PC), a laptop computer, a mobile device, a smartphone, a tablet computer, a smart watch, a wearable computer, a virtual reality device, an augmented reality devices, any combination of these delineated devices, or any other suitable device.

The client device(s) 102 may include an signed language conversion application 140, a renderer 142, and display 150. Although only a few components and/or features of the client device(s) 102 are illustrated in FIG. 1, this is not intended to be limiting. For example, the client device(s) 102 may include additional or alternative components, such as those described with respect to the computing device 800 of FIG. 8.

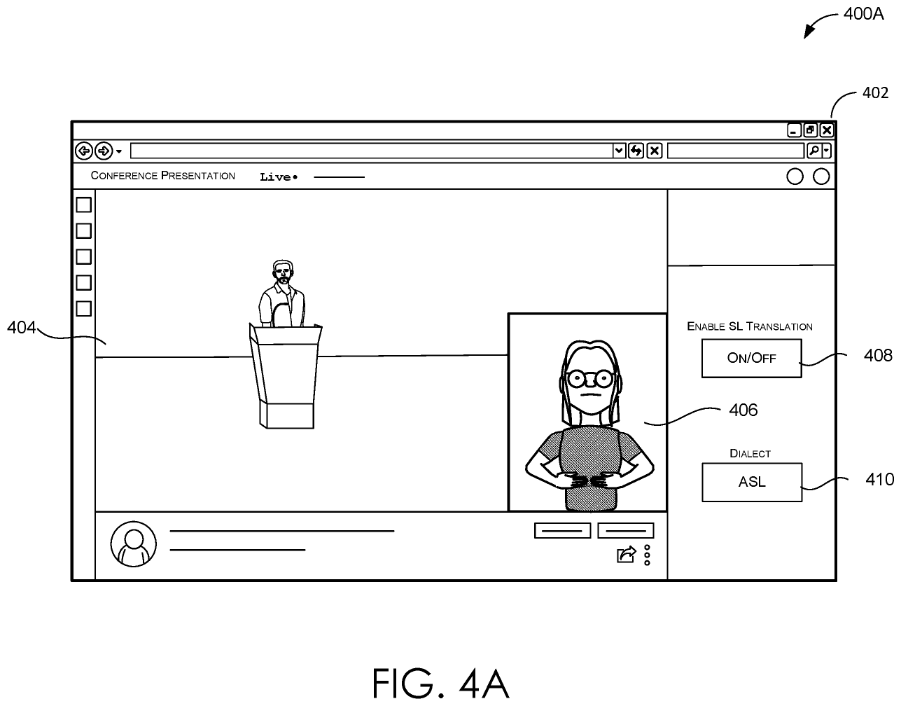

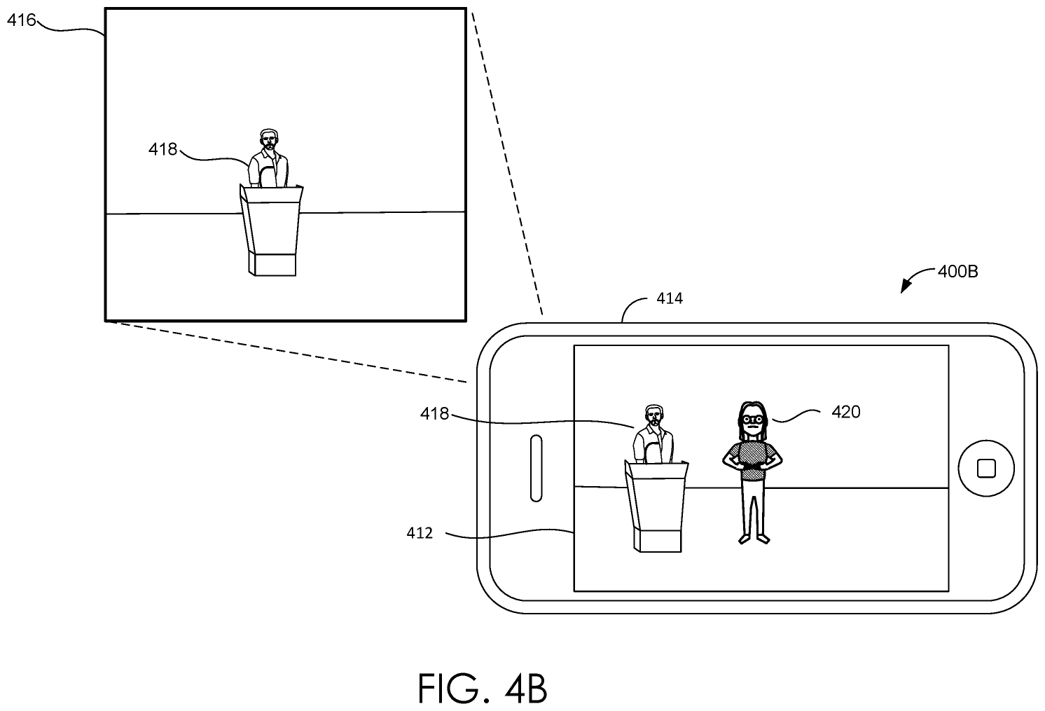

The application 140 may be a mobile application, a computer application, a console application, a web browser application, a game streaming platform application, and/or another type of software application or service. In some embodiments, multiple applications 140 may be employed. An application 140 may include instructions that, when executed by a processor(s), cause the processor(s) to cause display of an animated rigged model on the display 150. In other words, the application 140 may operate as a facilitator for enabling the streaming of video, audio, 2D and 3D animations, and/or other content associated with presenting the animated rigged model on the client devices 102. In some examples, the application 140 may receive one or more choreographic actions from the choreography server(s) 106 via the network 108, and may cause display of the animated rigged model on the display 150—such as GUI 400 of FIG. 4. In some examples, the application 140 may determine how, when, and/or where to display animated rigged models.

In some embodiments, the application 140 may utilize a renderer 142 to generate a display of a rigged model based on the one or more choreographic actions received from the choreography server(s) 106. For example, the client device(s) 102 may use the renderer 142 to process the one or more choreographic actions and/or rigging instructions from the rendering service 114 of the choreography server(s) 106 such that they may presented as an animated rigged model in the display 150.

The display 150 may include any type of display capable of displaying the video (e.g., a light-emitting diode display (LED), an organic LED display (OLED), a liquid crystal display (LCD), an active matrix OLED display (AMOLED), a quantum dot display (QDD), a plasma display, an LED/LCD display, and/or another type of display). In some examples, the display 150 may include more than one display (e.g., a dual-monitor display for computer gaming, a first display for configuring a game and a virtual reality display for playing the game, etc.).

The source device(s) 104 may include any device capable of generating, capturing, and/or transmitting media content. By way of example and not limitation, the source device(s) 104 may be embodied as one or more servers or any other suitable device. In some embodiments, the source device(s) 104 may be associated with a streaming service that provide audio and/or video streams. The source device(s) 104 may include a streaming client 140 that facilitates the streaming of audio or video content the client device(s) 102 and the choreography server(s) 106 using the network 108. In some embodiments, the streaming client 104 may access one or more content databases 132 that store recorded media content (e.g., audio or video) that may be streamed to the client device(s) 102. In one or more embodiments, the source device(s) 104 may be associated with live media 134 such as a live broadcast that is captured by source device(s) 104. Although the source device(s) 104 are depicted in FIG. 1 as being separate from the client device(s) 102, this is not intended to be limiting as in some embodiments, the source device(s) 104 and the client device(s) 102 may be implemented on the same devices. For example, a device comprising a camera that is capturing video of a live event may render an augmented reality overlay of the captured video on a display of the device.

The choreography server(s) 106 may include one or more servers for generating, training, managing, storing, and/or using components for determining and generating sign language choreography for 2D or 3D rigged models. The choreography server(s) 106 may include, among other things, one or more machine learning (ML) algorithm(s) 110, a reinforcement engine 112, a rendering service 114, and/or database 120. Although only a few components and/or features of the choreography server(s) 106 are illustrated in FIG. 1, this is not intended to be limiting. For example, choreography server(s) 106 may include additional or alternative components, such as those described below with respect to the computing device 800 of FIG. 8.

As further illustrated in FIG. 1, the choreography server(s) 106 may be separate or distinct from the source device(s) 104 and/or a client device(s) 102; however, this is not intended to be limiting. For example, the choreography server(s) 106 may be the same or similar servers to the source device(s) 104 and/or one or more components thereof may be at least partially on a client device(s) 102. In some embodiments, the choreography server(s) 106 may be owned and/or operated by a different entity than the source device(s) 104, while is other embodiments, the choreography server(s) 106 may be owned and/or operated by the same entity as the source device(s) 104.

The sign language translation server(s) 106 may comprise the one or more machine learning algorithm(s) 110 that may include one or more components and features for determining one or more choreographic actions corresponding to events and content presented in video and/or audio data. The ML algorithm(s) 110 may be trained to detect verbal and non-verbal characteristics associated with speech and/or expression that are represented in the ingested content. For example, the ML algorithm(s) 110 may be trained by the training engine 112 and used by the choreographic server(s) 106 to determine one or more choreographic actions. The choreographic actions may be used to animate a rigged model to produce sign language translations of the source content. Training ML algorithm(s) 110 to determine one or more choreographic actions for a sign language translation may include using image and/or audio data from the context of the source data as training data. The machine learning algorithm(s) 110 may output the one or more choreographic actions to the rendering service 114.

The rendering service 114 may comprise one or more components and features for instructing the orchestration of a rigged model. For example, the rendering service 114 may receive output from the machine learning algorithm(s) 110 that provide the rendering service with rigging instructions for a rigged model based on the determined choreographic actions. In some embodiments, the rigging instructions may be based on a desired sign language or dialect (e.g., ASL, FSL, etc.). For example, the rigging instructions corresponding to American Sign Language (ASL), may differ from rigging instructions corresponding to Filipino Sign Language (FSL). The rendering service 114 may provide the client device(s) 102 with the rigging instructions such that a rigged model may be animated according to the rigging instructions.

The reinforcement engine 112 may be used to train machine learning algorithm(s) of any type, such as machine learning algorithms using linear regression, logistic regression, decision trees, support vector machine (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptions, long/short terms memory, Hopfield, Boltzmann, deep belief, deconvolutional, generative adversarial, liquid state machine, etc.), and/or other types of machine learning algorithms.

Network 108 may be part of a communication network. In aspects, the network 108 may provide communication services from a service provider. The service provider may be a telecommunications service provider, an internet service provider, or any other similar service provider that provides at communication and/or data services to the client device(s) 102, source device(s) 104, and/or choreography server 106. For example, network 108 may be associated with a telecommunications provider that provides services (e.g., LTE) to the client device(s) 102, source device(s) 104, and/or choreography server 106. Additionally or alternatively, network 108 may provide voice, SMS, and/or data services to user devices or corresponding users that are registered or subscribed to utilize the services provided by a telecommunications provider. Network 108 may comprise any communication network providing voice, SMS, and/or data service(s), using any one or more wireless communication protocols, such as a 1× circuit voice, a 3G network (e.g., CDMA, CDMA2000, WCDMA, GSM, UMTS), a 4G network (WiMAX, LTE, HSDPA), or a 5G network. The network 108 may also be, in whole or in part, or have characteristics of, a self-optimizing network.

Having described sign language translation system 100 and components operating therein, it will be understood by those of ordinary skill in the art that the sign language translation system 100 is but an example of a suitable system and is not intended to limit the scope of use or functionality of aspects described herein. Similarly, sign language translation system 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 is an example, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1 it will be appreciated that some aspects may include a plurality of devices and/or components such that FIG. 1 should not be considered as limiting the quantity of any device and/or component.

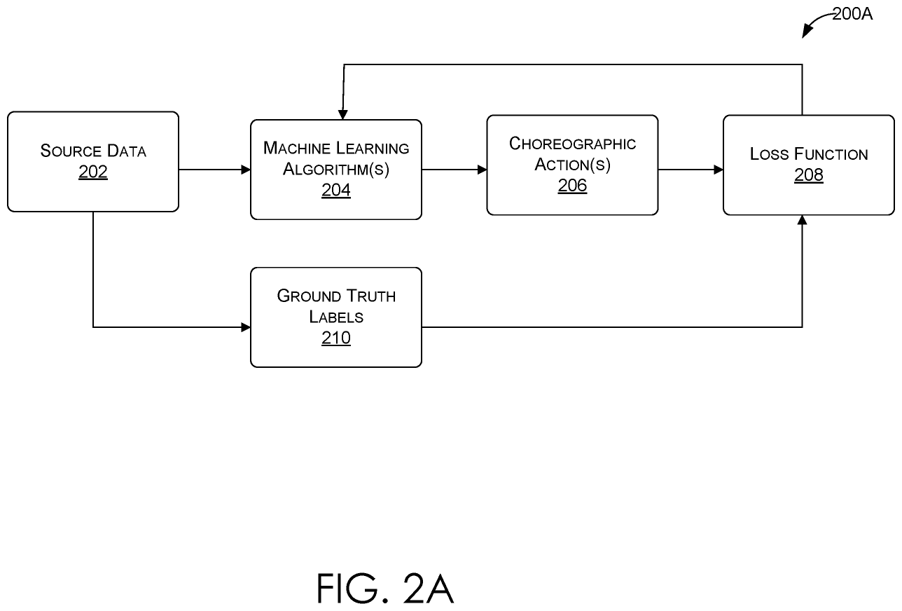

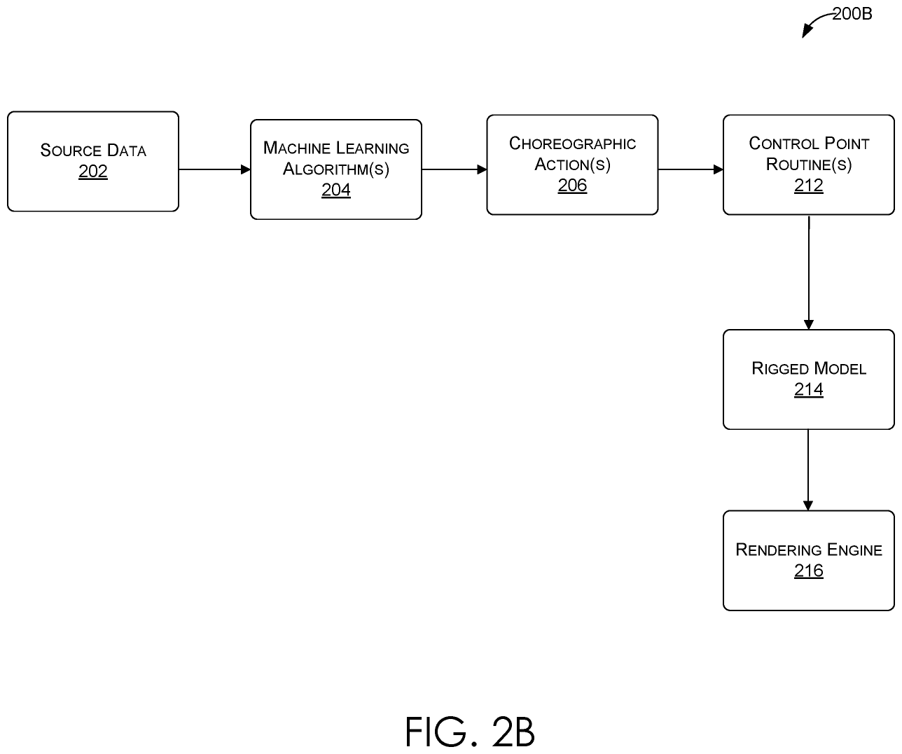

FIG. 2A depicts an example of a block diagram 200A showing a process training machine learning algorithms for spatially accurate sign language choreography, in accordance with embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Source data 202 comprising image data and/or audio data corresponding to a source content (e.g., audio or video stream) may be applied to the machine learning algorithm(s) (MLMs) 204 that may determine sign language translations based on the source data 202. The machine learning algorithm(s) 204 may be trained to detect one or more verbal or non-verbal characteristics that are represented in the source data 202. For example, the machine learning algorithm(s) 204 may be trained to identify the spoken and non-spoken (e.g., body language, facial expression, posture, etc.) characteristics of one or more people represented in the source data 202. Based on identifying the spoken and non-spoken characteristics in the source data 202, the MLMs 204 may output one or more choreographic action(s) 206.

The choreographic actions(s) 206 may indicate a particular sign language gesture or expression that is an estimated translation of the source data 202. The choreographic action(s) may be one sign language expression or may be a series of sign language expressions. In some embodiments, the choreographic actions(s) 206 may provide a sign language translation of the source data 206 into multiple sign language dialects and/or varieties. For example, the choreographic action(s) 206 output by the machine learning algorithm(s) 204 may comprise a translation of the source data 202 into American Sign Language (ASL) and Spanish Sign Language (LSE).

Ground truth labels 210 may be applied to the source data 202 and used to train the machine learning algorithm(s) 204. The ground truth labels 210 may be used in a loss function 208 to update parameters (e.g., weights and biases) of the machine learning algorithm(s) 204 until the machine learning algorithm(s) 204 converge to an acceptable or desirable accuracy. Machine learning algorithm(s) 204 may be trained to accurately predict the output choreographic actions from the source data 202 using the loss function 208 and the ground truth labels 210.

FIG. 2B depicts an example of a block diagram 200B showing a process for spatially accurate sign language choreography using machine learning algorithms, in accordance with embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The source data 202, machine learning algorithm(s) 204, and choreographic action(s) 206 may be similar to that described herein at least with respect to FIG. 2A. The source data 202 may be provided to the machine learning algorithm(s) 204 that have been trained to estimate the choreographic action(s) 206 corresponding to the source data 202. For example, the machine learning algorithm(s) 204 may output predicted choreographic action(s) 206 comprising one or more rigging instructions for the rendering engine 216 to orchestrate the animation of the rigged model 214.

Based on the choreographic actions(s) 206, control point routine(s) 212 can be determined. Control point routine(s) 212 define the spatial and temporal manipulation of control points associated with a rigged model 214. The control point routine(s) 212 enable a rigged model to be animated in accordance with the choreographic actions(s) 206 so the rigged model 214 may act as a virtual translator of the source data into a sign language that can be subsequently displayed to a user in relation to the display of the source content. The rigged model 214 may be rendered for display by the rendering engine 216. For example, the rendering engine 216 may perform operations causing an animation of the rigged model 214 to be displayed on one or more devices, such as the client device(s) 102 of FIG. 1. Displaying the rigged model enables a low latency virtual sign language translation of the source content.

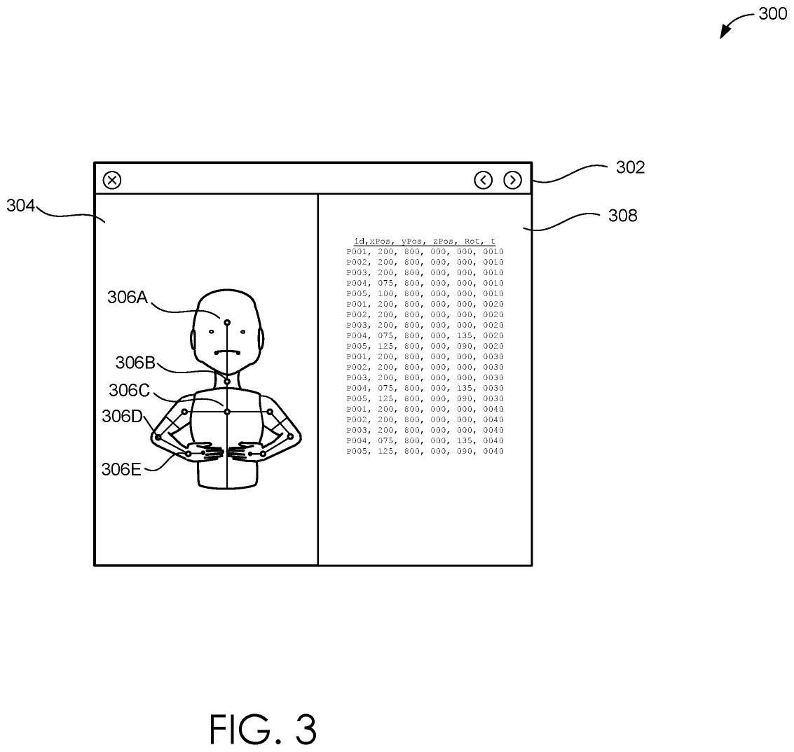

FIG. 3 depicts an example graphical user interface (GUI) 300 for displaying a rigged model, in accordance with implementation of the present disclosure. The GUI 300 may include one or more graphical elements such as graphical element 302. The graphical elements may include one or graphical regions such as the rigged model renderings 304 and choreographic routine instructions 308. The rigged model renderings 304 may include one or more depictions of one or more rigged models and may allow for a rigged model to be displayed, inspected, controlled, or otherwise interacted with. For example, the rigged model renderings 304 may allow a user to view a 3D rigged model from one or more viewing angles including viewing multiple angles or perspectives simultaneously. In some embodiments, the rigged model renderings 304 may allow for different viewable layers to be selectively included or otherwise made visible. For example, the rigged model renderings 304 may allow a user to select particular layers of a 3D rigged model (e.g., skeleton, wireframe, texture, etc.) that are visible and/or active within the GUI 300. The rigged model renderings 304 may enable the viewing and manipulation of one or more control points of a rigged model, such as control points 306A-E. The control points may be manipulated to cause the rigged model to move in accordance with the manipulated points. For example, one or more control points may be instructed to move to an updated position within a 3D coordinate system, with respect to particular reference points in the coordinate system, and/or other control points. The control points, such as control points 306A-E, may have a positional aspect (e.g., x, y, z positions) and may have a rotational aspect (e.g., expressed in angle, degrees, radians, etc.) such that the angular and/or radial displacement of the control points may be updated in accordance to manual or automatic manipulation. Information corresponding to the control points may be displayed, for example choreographic routine instructions 308, in association with the rigged model renderings 304. Choreographic routine instructions 308 may include information parameters associated with control points of a rigged model. For example the choreographic routine instructions 308 may include parameters defining point ID, position information, rotation information, and time. The choreographic routine instructions 308 may be used to update one or more control points of the rigged model over an interval of time as to generate an animation of the rigged model.

FIG. 4A depicts an example graphical user interface (GUI) 400A for displaying a rigged model, in accordance with implementation of the present disclosure. The GUI 400A may include one or more graphical elements depicting a geographic area, such as window 402. Window 402 may be presented in association to an application, website, and/or video stream. For example, the window 402 may include a video display 404 that corresponds to a streamed video such as a live video presentation or event. The video display 404 may depict live or pre-recorded content. The GUI 400A may include a graphical presentation of a 2D or 3D rigged model such as rigged model viewer 406. Rigged model viewer 406 may display a rigged model that is associated with the video display 404. For example the model viewer 406 may display a rigged model that is providing sign language translation for the content presented in the video display 404. In some embodiments, the rigged model viewer 406 may be displayed in the same window or application as the video display 404. For example, the rigged model viewer 406 may be presented as a picture-in-picture with the video display 404. In some embodiments, the GUI 400A may provide controls that allow for a user to control a rigged model that is displayed in a rigged model viewer 406. For example, a translation selection 408 may enable a user to activate/deactivate a sign language translation service and the associated display of a rigged model. Activating the translation selection 408 may cause the GUI 400A to display the rigged model viewer 406 within the window 402 or another interface. The GUI 400A may also include controls, such as dialog selector 410, which enables the selection of a particular dialect or regionalism for sign language translation. For example, the dialect selector 410 may allow a user to select a sign language dialect (e.g., ASL) that can be provide to components of the translation system, such as the machine learning algorithm(s) of FIG. 1, to generate choreographic actions to cause the rigged model displayed in the rigged model viewer 406 to move in accordance with the selected sign language dialect.

FIG. 4B depicts an example graphical user interface (GUI) 400B for displaying a rigged model in augmented reality, in accordance with implementation of the present disclosure. The GUI 400B may include one or more graphical elements depicting a geographic area, such as display 412. Display 412 may be presented in association with a device capable of rendering and/or displaying augmented reality content. For example, the display 412 may be presented in association to AR device 414. AR device 414 may comprise one or more components associated with the presentation of AR content. For example, AR device 414 may comprise one or more processors, sensors, input devices, imaging components, projectors, and/or display components. AR device 414 may comprise one or more cameras, microphones, and audio/image sensors that enable the AR device 414 to capture audio and/or video in real-time. For example, the AR device 414 may have a camera that can capture video of one or more subjects 418 of a live event 416. In some embodiments, the AR device 414 may display a rendering of a rigged model 420 that is providing sign language translation of subjects 418 or the live event 416 within the display 412. model viewer 406 may be presented as a picture-in-picture with the video display 404. For example, the display 412 may depict the rigged model 420 as an overlay, projection, and/or augmentation to media corresponding to the live event 416 captured by the AR device 414.

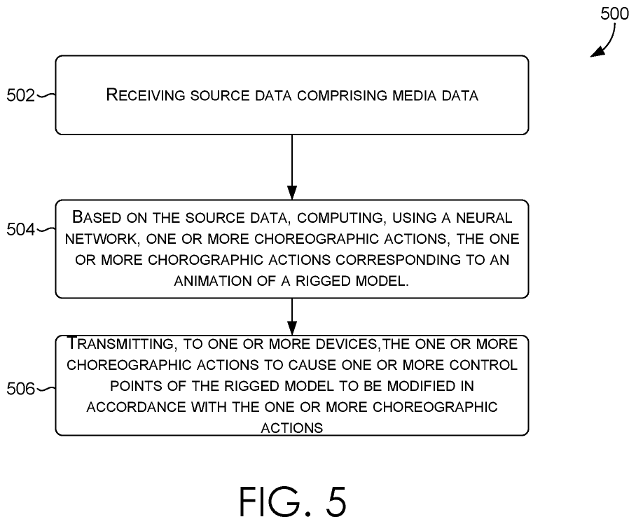

Now referring to FIGS. 5-7, each block of methods 500, 600, and 700, described herein, comprises a computing process that may be performed using any combination of hardware, firmware, and/or software. For instance, various functions may be carried out by a processor executing instructions stored in memory. The methods 500, 600, and 700 may also be embodied as computer-usable instructions stored on computer storage media. The methods 500, 600, and 700 may be provided by a standalone application, a service or hosted service (standalone or in combination with another hosted service), or a plug-in to another product, to name a few. In addition, the methods 500, 600, and 700 are described, by way of example, with respect to the system of FIG. 1. However, these methods may additionally or alternatively be executed by any one system, or any combination of systems, including, but not limited to, those described herein.

FIG. 5 is a flow chart illustrating an example method 500 for spatially accurate sign language choreography in video translation systems, in accordance with aspects of the present disclosure. It should be understood that while FIG. 5 depicts just one particular arrangement and/or order of steps, other arrangements and/or orders of steps are possible and contemplated by the disclosed herein. For instance, one or more of the steps depicted in FIG. 5, may be performed in a different order or otherwise omitted.

At step 502 of the method 500, source data may be received, for example, by the choreography server(s) 106 of FIG. 1. For example, The choreography server(s) 106 may receive source data, including media data such as audio and/or image data, from one or more source device(s) 104. For instance, a source device may transmit, over the network 108, a video stream of audio and/or video content that is received with the choreography server(s) 106. In some embodiments, the source data may be received by the choreography server(s) 106 and one or more client device(s) 102.

At step 504 of method 500, one or more choreographic actions are computed. In some embodiments, the one or more choreographic actions are determined using a neural network that may be applied to at least the source data. For example, a neural network trained to determine one or more choreographic actions or animations based on providing audio and/or image data as input. In some embodiments, the one or more choreographic actions correspond to an animation of a rigged model. For example, the choreographic actions may be used to determine how a spatially rigged 3D model will appear and be displayed as an animation corresponding to the source content.

At step 506 of the method 500, the one or more choreographic actions may be transmitted, to one or more devices, to cause one or more control points of the rigged model to be modified in accordance with the one or more choreographic actions. For example, the choreographic actions may be transmitted to a component of the choreography severs(s) 106 and/or client device(s) 102 to enable a rigged model to be animated based on manipulating control points of the rigged model.

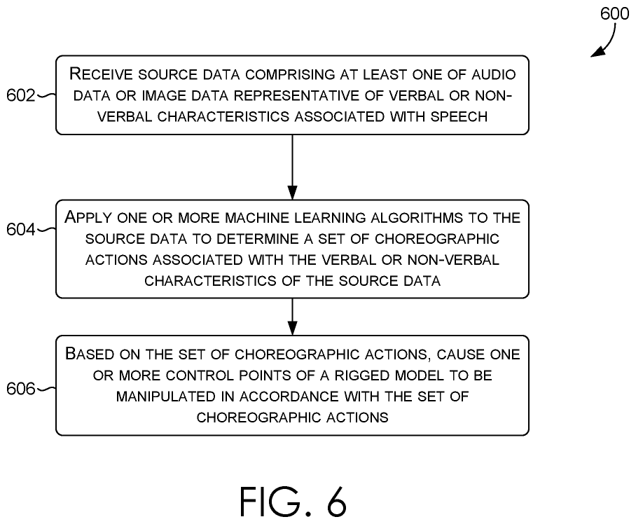

FIG. 6 is a flow chart illustrating an example method 600 for spatially accurate sign language choreography in video translation systems, in accordance with aspects of the present disclosure. It should be understood that while FIG. 6 depicts just one particular arrangement and/or order of steps, other arrangements and/or orders of steps are possible and contemplated by the disclosed herein. For instance, one or more of the steps depicted in FIG. 6, may be performed in a different order or otherwise omitted.

In step 602 of method 600, source data may be received. The source data may comprise at least one of audio data or image data that is representative of verbal or non-verbal characteristics associated with speech. For example, the source data may comprise audio data and image data that is representative of speech within content, such as a person speaking or presenting, such that the verbal aspects of the content and the non-verbal aspects of the content may be captured or otherwise represented in the source data.

Step 604 of the method 600, one or more machine learning algorithms may be applied to the source data to determine a set of choreographic actions associated with the verbal or non-verbal characteristics of the source data. For example, the machine learning algorithm(s) 110 may be used to calculate a set of choreographic actions that are estimated to translate the verbal and/or non-verbal characteristics of the source data for a rigged model.

At step 606 of the method 600, based on the set of choreographic actions, one or more controls points of a rigged model may be manipulated in accordance with the set of choreographic actions. For example, a rigged model displayed in the display 150 of client device(s) 102 may be animated according to the set of choreographic actions by updating the positional and rotational aspects of the control points associated with the rigged model. The animation of the rigged model may act as a sign language translation of the source content. For example, the control points of the rigged model may be manipulated to produce an animation of one or more sign language gestures in the rigged model.

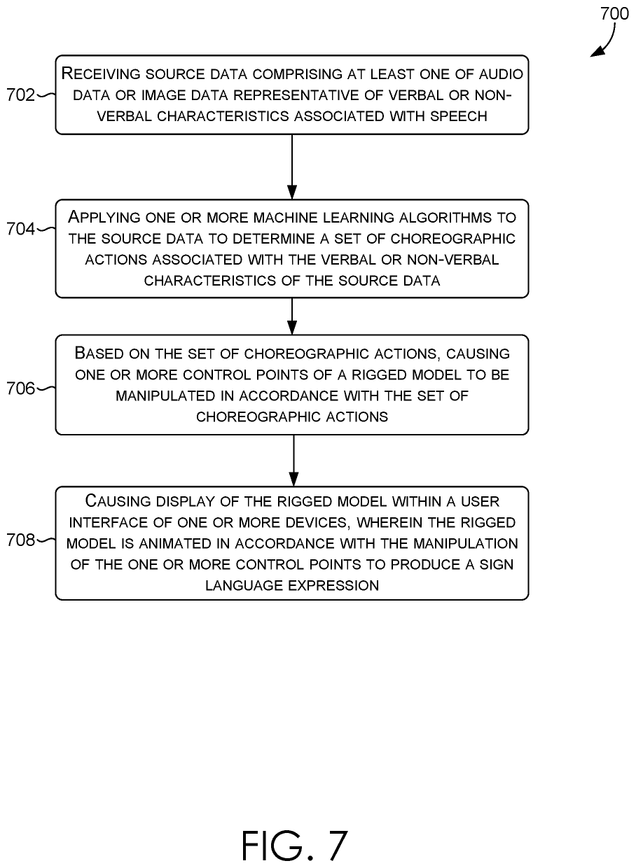

FIG. 7 is a flow chart illustrating an example method 700 for spatially accurate sign language choreography in video translation systems, in accordance with aspects of the present disclosure. It should be understood that while FIG. 7 depicts just one particular arrangement and/or order of steps, other arrangements and/or orders of steps are possible and contemplated by the disclosed herein. For instance, one or more of the steps depicted in FIG. 7, may be performed in a different order or otherwise omitted.

In step 702 of method 700, source data may be received. The source data may comprise at least one of audio data or image data that is representative of verbal or non-verbal characteristics associated with speech. For example, the source data may comprise audio data and image data that is representative of speech within content, such as a person speaking or presenting, such that the verbal aspects of the content and the non-verbal aspects of the content may be captured or otherwise represented in the source data.

Step 704 of the method 700, one or more machine learning algorithms may be applied to the source data to determine a set of choreographic actions associated with the verbal or non-verbal characteristics of the source data. For example, the machine learning algorithm(s) 110 may be used to calculate a set of choreographic actions that are estimated to translate the verbal and/or non-verbal characteristics of the source data for a rigged model.

At step 706 of the method 700, based on the set of choreographic actions, one or more controls points of a rigged model may be manipulated in accordance with the set of choreographic actions. For example, a rigged model displayed in the display 150 of client device(s) 102 may be animated according to the set of choreographic actions by updating the positional and rotational aspects of the control points associated with the rigged model. The animation of the rigged model may act as a sign language translation of the source content. For example, the control points of the rigged model may be manipulated to produce an animation of one or more sign language gestures in the rigged model.

At step 708 of the method 700, causing display of the rigged model is within a user interface of one or more devices, wherein the rigged model is animated in accordance with the manipulation of the one or more control points to produce a sign language expression. For example, a rigged model displayed in the display 150 of client device(s) 102 and may be animated to produce a sign language translation of the source content by displaying a sign language expression and/or gesture.

Referring now to FIG. 8, a diagram is depicted of an exemplary computing environment suitable for use in implementations of the present disclosure. In particular, the exemplary computer environment is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 8, computing device 800 includes bus 810 that directly or indirectly couples the following devices: memory 812, one or more processors 814, one or more presentation components 816, input/output (I/O) ports 818, I/O components 820, power supply 822 and radio(s) 824. Bus 810 represents what may be one or more busses (such as an address bus, data bus, or combination thereof). Although the devices of FIG. 8 are shown with lines for the sake of clarity, in reality, delineating various components is not so clear, and metaphorically, the lines would more accurately be grey and fuzzy. For example, one may consider a presentation component, such as a display device to be one of I/O components 820. Also, processors, such as one or more processors 814, have memory. The present disclosure hereof recognizes that such is the nature of the art, and reiterates that FIG. 8 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 812 includes computer-storage media in the form of volatile and/or nonvolatile memory. Memory 812 may be removable, non-removable, or a combination thereof. Exemplary memory includes solid-state memory, hard drives, optical-disc drives, etc. Computing device 800 includes one or more processors 814 that read data from various entities, such as bus 802, memory 812, or I/O components 820. One or more presentation components 816 presents data indications to a person or other device. Exemplary one or more presentation components 816 include a display device, speaker, printing component, vibrating component, etc. I/O ports 818 allow computing device 800 to be logically coupled to other devices, including I/O components 820, some of which may be built in computing device 800. Illustrative I/O components 820 include a microphone, joystick, game pad, satellite dish, scanner, printer, wireless device, etc.

Radio(s) 824 represents a radio that facilitates communication with a wireless telecommunications network. Illustrative wireless telecommunications technologies include CDMA, GPRS, TDMA, GSM, and the like. Radio 816 might additionally or alternatively facilitate other types of wireless communications including Wi-Fi, WiMAX, LTE, or other VoIP communications. As can be appreciated, in various embodiments, radio 824 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. A method comprising:
receiving source data comprising media data;
based on the source data, computing, using a neural network, one or more choreographic actions, the one or more chorographic actions corresponding to an animation of a rigged model; and
transmitting, to one or more devices, the one or more choreographic actions to cause one or more control points of the rigged model to be modified in accordance with the one or more choreographic actions.

2. The method of claim 1, wherein the one or more control points of the rigged model define movement of the rigged model in a 3D space.

3. The method of claim 1, wherein the rigged model is displayed within a user interface of the one or more devices.

4. The method of claim 1, the source data comprises video data associated with a live image stream.

5. The method of claim 1, wherein the neural network has been trained to compute the one or more choreographic actions based on verbal and non-verbal characteristics of an event represented by the source data.

6. The method of claim 1, wherein the one or more choreographic actions are associated with one or more signed languages.

7. The method of claim 1, wherein computing the one or more choreographic actions is based on a selection of a sign language dialect.

8. The method of claim 1, wherein the rigged model is displayed with a user interface of the one or more devices, the user interface of the one or more devices also displaying a representation of the source data.

9. A system comprising:
one or more processors; and
one or more computer storage hardware devices storing computer-usable instructions that, when used by the one or more processors, cause the one or more processors to:
receive source data, the source data comprising at least one of audio data or image data representative of verbal or non-verbal characteristics associated with speech;
apply one or more machine learning algorithms to the source data to determine a set of choreographic actions associated with the verbal or non-verbal characteristics of the source data; and
based on the set of choreographic actions, cause one or more control points of a rigged model to be manipulated in accordance with the set of choreographic actions.

10. The system of claim 9, wherein the one or more control points of the rigged model are updated to generate an animation of a sign language expression in the rigged model.

11. The system of claim 9, wherein the manipulation of the control points of the rigged model causes an animation of the rigged model to be presented in a user interface of one or more devices.

12. The system of claim 9, wherein the source data is associated with live content streaming.

13. The system of claim 9, wherein the one or more machine learning algorithms have been trained to determine the set of choreographic actions based on verbal and non-verbal characteristics of an event represented by the source data and at least one dialect of a signed language.

14. The system of claim 9, wherein determining the set of choreographic actions is based on a selection of a sign language dialect within a user interface.

15. The system of claim 9, wherein the rigged model is displayed with a user interface of one or more devices, the user interface of the one or more devices also displaying a visualization of the source data.

16. One or more computer-readable media having computer-executable instructions embodied thereon that, when executed, perform a method for animating a sign language in a rigged model, the method comprising:
receiving source data, the source data comprising at least one of audio data or image data representative of verbal or non-verbal characteristics associated with speech;
applying one or more machine learning algorithms to the source data to determine a set of choreographic actions associated with the verbal or non-verbal characteristics of the source data;
based on the set of choreographic actions, causing one or more control points of a rigged model to be manipulated in accordance with the set of choreographic actions; and
causing display of the rigged model is within a user interface of one or more devices, wherein the rigged model is animated in accordance with the manipulation of the one or more control points to produce a sign language expression.

17. The media of claim 16, wherein the rigged model is displayed with a user interface of one or more devices, the user interface of the one or more devices also displaying a visualization of the source data.

18. The media of claim 16, wherein determining the set of choreographic actions is based on a selection of a sign language dialect within a user interface

19. The media of claim 16, wherein the one or more machine learning algorithms have been trained to determine the set of choreographic actions based on verbal and non-verbal characteristics of an event represented by the source data and at least one dialect of a signed language.

20. The media of claim 16, wherein the source data is associated with a streaming service.
